(19) United States
(12) Patent Application Publication
(10) Pub. No.: US 2004/0199470 A1
(43) Pub. Date: Oct. 7, 2004

(54) Electronic transaction notification system and method

(75) Inventors: Earl N. Ferry JR., Plano, TX (US); Marsha C. Ferry, Plano, TX (US)

Correspondence Address: Michael L. Diaz, Michael L. Diaz, P.C., Suite 200, 555 Republic Drive, Plano, TX, 75074, US

(73) Assignee: BYTE MAGE, L.L.C.

(21) Appl. No.: 10/405,554

(22) Filed: Apr. 2, 2003

(51) Int. Cl. G06F 17/60

(52) U.S. Cl. 705/44; 705/16; 705/39

(57) ABSTRACT

A system and method of notifying a specified destination of a completed electronic transaction. The system includes an authorization center and a transaction notification system. A purchaser conducts an electronic transaction, such as a credit card transaction, with a merchant. The merchant queries the authorization center to determine if the transaction is authorized. The authorization center then determines if the transaction is authorized. Upon determining if the transaction is authorized, the authorization center sends an authorization message to the merchant. In addition, the authorization center sends a message to the transaction notification system. The transaction notification system generates a transaction message from the received message and sends the transaction message to one or more specified destinations. The destinations may include an email message sent to an email account, a voice message to a communication device, or a text message to a communication device.

### BACKGROUND OF THE INVENTION

1. Technical Field of the Invention

This invention relates to electronic transactions, and more particularly, to a system and method of notifying a specified destination of an electronic transaction.

2. Description of Related Art

The use of credit cards and associated electronic transactions has exploded over the past two decades. Electronic transactions, such as credit card transactions, account for the transfer of trillions of dollars each year. However, the proliferations of credit cards has been accompanied by the rapid growth of fraudulent credit card use. Because of the widespread use of credit cards, it is nearly impossible to provide an efficient and effective method of preventing fraudulent credit card use. Although the liability to rightful credit card users for fraudulent use by others of their credit cards is limited, there still is some amount for which the credit card holder is accountable. For the remaining amount attributed to fraudulent credit card use, the credit card companies must pay. The credit card companies lose billions of dollars to fraudulent credit card usage each year. This problem is exacerbated by the fact that the fraudulent credit card usage is sometimes not recognized for a long period of time. During this unrecognized period of time, the fraudulent transactions continue to take place. Thus, timely recognition of these fraudulent transactions is imperative to mitigate the loss of money.

In addition, oftentimes two or more persons share a joint account. For example, check cards which act as credit cards yet draw from a conventional checking account are quite common. When two people share one account, one person will not be immediately aware of all transactions conducted by the other person. With a checking account, lack of knowledge of the counterpart's transaction can result in the overdrawing of the checking account. Additionally, although there is online banking which provides an accounting of such transactions, there is often a lag of time from the transaction until the account shows the transaction.

In still other situations, a credit card may be issued to one person for whom another is responsible for payment. It is common for adults to provide a credit card to their children, especially college students living away from home, for which the adult pays the bill. It is common knowledge that many children do not always act responsibly when using these credit cards. It may take one or more months until the adult is made aware of any irresponsible credit card usage by their children.

Credit cards are also sometimes associated with a company for which its employees are issued “corporate credit cards.” The use of these cards is usually limited to company related expenses. In a similar manner as children using their parent's credit cards, employees do not always act responsibly using their corporate credit cards. Again, responsible parties are often unaware of any questionable transactions until several months after the completion of the transactions.

The use of credit cards has brought about a convenience and flexibility to users which was unknown in the past. But because of their growing use, the above-mentioned problems, as well as other problems occur. With the difficulty in preventing the fraudulent use of credit cards, the next best step is to provide timely notification to specified individuals of each and every transaction.

Although there are no known prior art teachings of a solution to the aforementioned deficiency and shortcoming such as that disclosed herein, prior art references that discuss subject matter that bears some relation to matters discussed herein are U.S. Pat. No. 5,530,438 to Bickham et al. (Bickham), U.S. Pat. No. 5,708,422 to Blonder et al. (Blonder), and U.S. Pat. No. 6,327,348 to Walker et al. (Walker).

Bickham discloses a system providing an alert of a financial transaction. A radio system user is alerted to an occurrence of a financial transaction by a customer. Data is obtained from the customer and used to identify a radio system user who is authorized to conduct the transaction. A message, indicative of the financial transaction, is automatically provided to a radio system and broadcast to the radio system user to alert the user of the financial transaction. However, Bickham suffers from several limitations. First, the user must be a radio system user (e.g., a pager or mobile phone) which requires the use of additional equipment by the user. Secondly, each and every merchant must have additional equipment, namely transmitters for transmitting the signal over the radio system. In addition, Bickham triggers a response during the transaction, rather than after completion of the transaction. By notifying the radio system user during the transaction, the credit card transaction must perform an additional step prior to completion of the transaction. This concurrent notification can slow the credit card transaction process, thus providing an unwanted delay prior to completion of the transaction.

Blonder discloses an automated method for alerting a customer that a transaction is being initiated before authorizing the transaction, based on a confirmation/approval by the customer. A request to authorize a transaction is received by a validation database. The validation database sends an alert of the initiation of the transaction to the credit card user. The credit card user must then authorize the transaction within certain specified parameters. The transaction is complete upon receipt of the authorization by the credit card user. Blonder does not teach or suggest notifying a specific individual at the completion of the transaction. Rather, Blonder discloses a system which alerts a person at the initiation of the transaction. In addition, Blonder requires that the user provide an authorization for specified transaction, prior to completion of the transaction. Blonder also requires the use of a modified credit card clearing house (a validation database), rather than employing a standalone system. Thus, Blonder must substantially modify the credit card clearing house, which may be expensive and impractical. Additionally, Blonder suffers from the disadvantage of actually slowing the transaction process from start to completion.

Walker discloses a method and apparatus for controlling credit card use. The method includes the steps of linking a first and second person to a financial account that is used for the transaction. The first person must authorize a transaction conducted by the second person prior to completion of the transaction. Walker does not teach or suggest notification of a completed transaction, but merely discloses notification of a transaction in progress. In order for a transaction to be authorized, the first person must authorize the transaction. Walker is impractical when a transaction needs to be authorized, yet the first person is not readily available to authorize the transaction. In addition, the transaction time is definitively slowed by the addition of another step in the authorization process.

All of the above references do not notify a specific party after the completion of a transaction. Review of each of the foregoing references reveals no disclosure or suggestion of a system and method as that described and claimed herein. Thus, it would be a distinct advantage to have a system and method which provides a notification of an electronic transaction after completion of the transaction. Additionally, it would be advantageous to have a system which does not require extensive modification to existing credit card/electronic transaction systems as well as providing minimal impact on existing credit card transaction systems. It is an object of the present invention to provide such a system and method.

### SUMMARY OF THE INVENTION

In one aspect, the present invention is a system for notifying a specified destination of a transaction. The system includes an authorization center receiving authorization requests from a merchant for a specific transaction associated with a specific account. The authorization system may be a separate entity or incorporated with a financial institution or card issuer. The authorization center authorizes the specific transaction and sends an authorization message to the merchant. In addition, the system includes a transaction notification system for transmitting a transaction message to a specified destination or plurality of destinations associated with the specific account. The transaction notification system receives a message from the authorization center upon completion of the transaction. The transaction notification system then sends the transaction message upon completion of the specific transaction by the authorization center to the specified destination.

In another aspect, the present invention is a method of notifying a specified destination of an electronic transaction by a purchaser. The method begins by the purchaser conducting an electronic transaction using a specified account. Next, the merchant requests authorization for the transaction to an authorization center. The authorization center then determines if the electronic transaction is authorized. An authorization message is then sent to the merchant. In addition, the authorization center sends a message to a transaction notification system about the completed transaction. The transaction notification system then sends a transaction message to the specified destination associated with the specified account. The transaction message provides information about the electronic transaction.

In still another aspect, the present invention is a system for notifying a specified destination of a transaction. The system includes an authorization center for receiving authorization requests from a merchant for a specific transaction associated with a specific account. The authorization center authorizes the specific transaction and sends an authorization message to the merchant. In addition, the system includes a transaction notification system for transmitting a transaction message to a specified destination associated with the specific account. The transaction notification system receives a message from the authorization center during a specific transaction. The transaction message is transmitted during the specific transaction.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a block diagram illustrating an existing credit card transaction;

FIG. 2 is a block diagram illustrating a credit card communication system in the preferred embodiment of the present invention;

FIGS. 3A and 3B are flow charts outlining the steps for notifying a specified party of an electronic transaction in a first embodiment of the present invention; and

FIGS. 4A and 4B are flow charts outlining the steps for notifying a specified party of an electronic transaction in a second embodiment of the present invention.

### DETAILED DESCRIPTION OF EMBODIMENTS

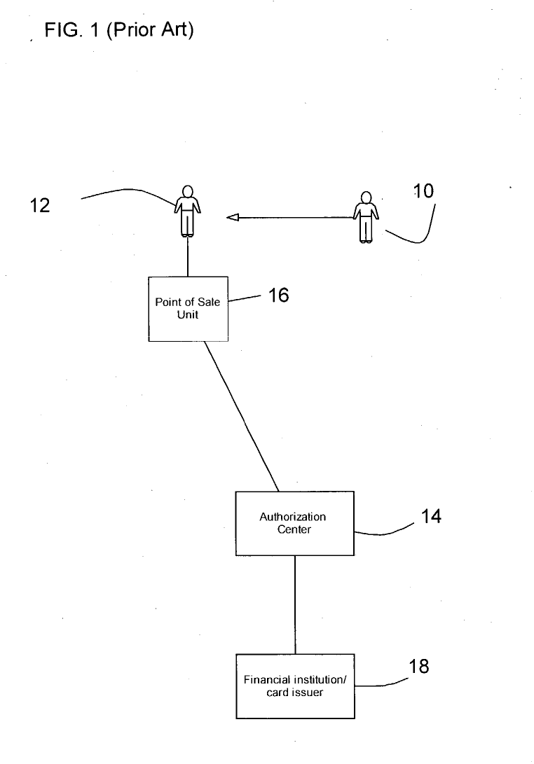

A system and method of notifying a specified party of an electronic transaction is disclosed. FIG. 1 is a block diagram illustrating an existing credit card transaction. A purchaser 10 may buy an item from a merchant 12 using a credit card. The merchant then requests authorization for the credit card transaction by communicating with an authorization center 14. Communication between the authorization center and merchant is usually conducted via a point of sale unit 16 located at the premises of the merchant. The point of sale unit is typically a device which reads a magnetic strip associated with the credit card used by the purchaser. The authorization center then verifies that the purchaser's credit card account is a valid account and has available credit by querying an issuing financial institution/card issuer 18. The issuing financial institution/card issuer keeps and processes all transactions of the purchaser's credit card account. The issuing financial institution/card issuer then responds to the query by either authorizing or rejecting the requested credit card transaction. The authorization center then relays the authorization or rejection message to the merchant. The merchant, upon receiving proper authorization from the authorization center, delivers the item to the purchaser.

As discussed above, several problems arise with existing credit card transactions. The actual person responsible for the credit card account may not be using the credit card. Sometimes, credit cards or identifying numbers, are stolen. In other situations, these credit cards are associated with several card holders. In any case, specified parties are not timely notified of completion of a transaction.

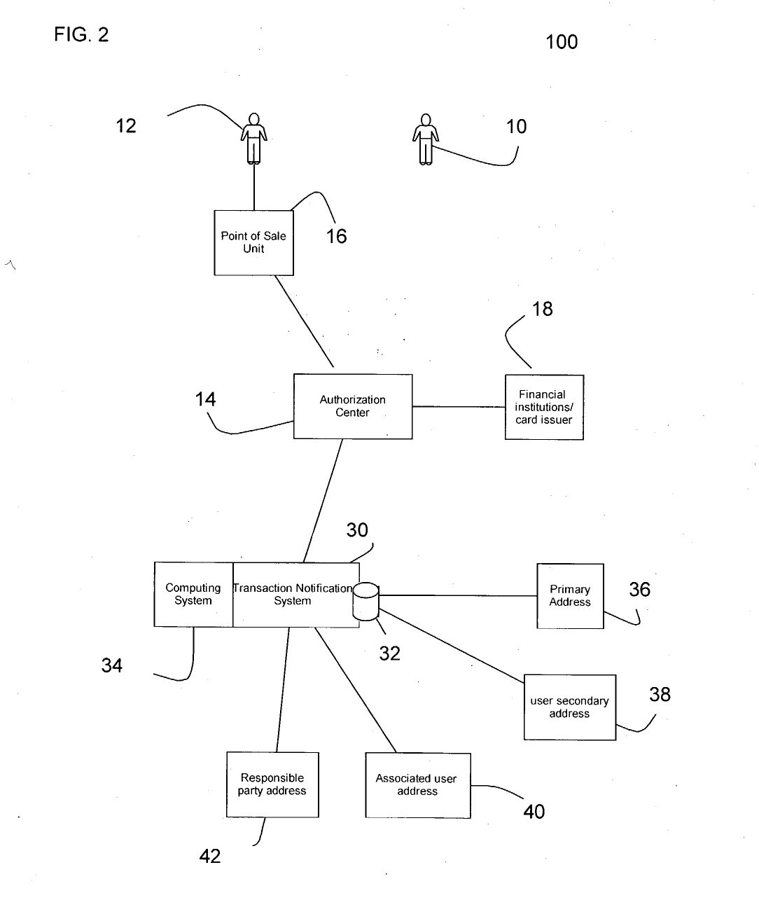

FIG. 2 is a block diagram illustrating a credit card communication system 100 in the preferred embodiment of the present invention. The credit card communication system includes a transaction notification system 30 having a database 32 and a computing system 34. Within the database 32 is stored a plurality of accounts associated with a credit card utilized by the purchaser 10. The purchaser may provide one or more destinations for which notifications may be sent at the completion of each transaction associated with the credit card. The destinations may include a user primary address 36, a user secondary address 38, an associated user address 40, or a responsible party address 42. It should be understood that the notification message may be sent to any destination that is specified. The destination is stored within the database for communication by the transaction notification system 30.

The transaction notification system 30 sends a notification (transaction) message to each specified destination. The notification message may be any electronic notification. For example, an email message may be sent to a specified email address. Additionally, a pager or mobile phone may be provided with notification that a transaction has been conducted. Additionally, a machine generated voice message may be sent to a specified telephone number. The message may include various types of information about the transaction, such as the merchant, the amount of transaction, a date stamp, and a location of the transaction. All of this information, or only selected items may be included in the message. In the preferred embodiment of the present invention, each transaction triggers a notification message. However, the transaction notification system may be temporarily suspended by a card holder or authorized individual. The temporary suspension may include suspense of one or more transaction messages or for a period of time as specified by the authorized party. Additionally, the transaction message may be suspended to one or more destinations.

The computing system 34 receives a transaction message from the authorization center 14. From this transaction message, the computing system determines the appropriate destination or destinations for transmittal of a transaction message. In addition, the computing system generates the appropriate message for transmittal.

The transaction message sent from the authorization center 14 to the financial institution/card issuer 18 may be replicated for transmission to the transaction notification system 30. In an alternate embodiment of the present invention, the transaction message may include information whether the authorization center 14 actually authorized or declined the transaction. In still another alternate embodiment, the transaction message may be sent from the financial institution/card issuer 18 directly to the transaction notification system. In this embodiment, the transaction message may be a replicated authorization message (indicating approval or disapproval of the transaction) sent to the authorization center 14. In another alternate embodiment, the financial institution/card issuer performs the function of sending the transaction message. Specifically, the financial institution/card issuer performs the function of the transaction notification system, whereby the financial institution/card issuer sends a transaction message directly to the specified destination or destinations.

It should be understood that although a credit card transaction is illustrated, any electronic transaction may utilize the present invention. For example, checks commonly are scanned into a point of sale unit for transmittal to financial institutions.

With reference to FIG. 2, the present invention will now be explained. The purchaser 10 buys an item from the merchant 12 using a credit card. The merchant then requests authorization for the credit card transaction by communicating with an authorization center 14 through the point of sale unit 16.

The merchant communicates with the authorization center 14, which typically processes credit card transactions utilizing the Automated Clearing House (ACH) Network to authorize a credit card transaction. The ACH Network is a processing and delivery system that provides for the distribution and settlement of electronic credits and debits among a large number of financial institutions. The acquiring processor may be a financial institution or a third party processor. The acquiring processor communicates with the financial institution/card issuer 18. The existing credit card transaction system is discussed for illustration only. The present invention may be implemented on any credit card transaction system. The merchant may also optionally communicate with a PIN confirmation and fraud prevention system (e.g., CyberSource, CyberCash, Digital Identification), or other method of verifying the identity of the purchaser and the validity of,the purchase.

The authorization center 14 then verifies that the purchaser's credit card account is a valid account and has available credit by querying the issuing financial institution/card issuer 18 with a transaction request message. The authorization center also sends a transaction request message to the transaction notification system 30. The transaction notification system receives the transaction request message. The computing system 34 retrieves from the database 32 account information associated with the credit card used by the purchaser 10. The account information includes the desired destinations and modes of communications for receipt of a transaction message. The transaction message is generated by the computing system. The transaction message may include information derived from the transaction request message received from the authorization center 14. The transaction message may include the account number, amount of transaction, merchant, location of merchant, and time of transaction.

During the credit card transaction, the issuing financial institution/card issuer 18 then responds to the query by either authorizing or rejecting the requested credit card transaction. The authorization center then relays the authorization or rejection message to the merchant. The merchant, upon receiving proper authorization from the authorization center, delivers the item to the purchaser.

The transaction notification system 30 then sends the generated transaction message to the specified destinations, such as the user primary address 36, the user secondary address 38, the associated user address 40 and/or the responsible party address 42. As discussed above, the transaction message may be sent to any specified address. The user may have one or more destinations for which the transaction message may be received. Additionally, the transaction message may be in a format allowing manual or automatic input into a financial software program which tracks transactions for the account. This may be in a manner similar to existing online banking procedures for retrieval and input into financial programs.

In another embodiment of the present invention, the purchaser 10 buys an item from the merchant 12 using a credit card. The merchant then requests authorization for the credit card transaction by communicating with an authorization center 14 through the point of sale unit 16. The authorization center then verifies that the purchaser's credit card account is a valid account and has available credit by querying the issuing financial institution/card issuer 18 with a transaction request message.

During the credit card transaction, the issuing financial institution/card issuer 18 then responds to the query by either authorizing or rejecting the requested credit card transaction. The authorization center then relays the authorization or rejection message to the merchant. The merchant, upon receiving proper authorization from the authorization center, delivers the item to the purchaser.

The authorization center 14 may also send a transaction request/authorization message to the transaction notification system 30. The transaction notification system receives the transaction request/authorization message. The computing system 34 retrieves from the database 32 account information associated with the credit card used by the purchaser 10. The account information includes the desired destinations and modes of communications for receipt of a transaction message. The transaction message is generated by the computing system. The transaction message may include information derived from the transaction/authorization request message received from the authorization center 14. The transaction message may include the account number, amount of transaction, merchant, location of merchant, and time of transaction. Additionally, the transaction message may include information on whether the transaction was approved or declined.

The transaction notification system 30 then sends the generated transaction message to the specified destinations, such as the user primary address 36, the user secondary address 38, the associated user address 40 and/or the responsible party address 42. The transaction message may be sent to any specified address. The user may have one or more destinations for which the transaction message may be received.

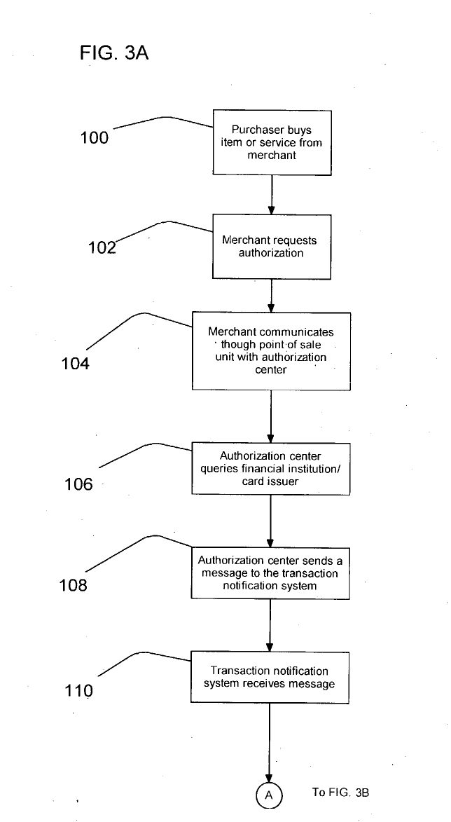

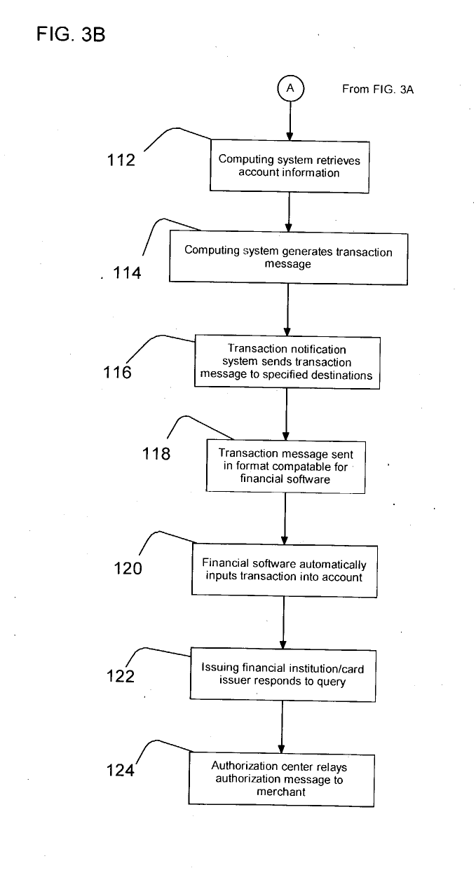

FIGS. 3A and 3B are flow charts outlining the steps for notifying a specified party of an electronic transaction in a first embodiment of the present invention. With reference to FIGS. 2, 3A and 3B, the steps of the method will now be described. Beginning with step 100, the purchaser 10 buys an item or a service from the merchant 12 using a credit card. Next, in step 102, the merchant requests authorization for the credit card transaction by communicating with an authorization center 14 through the point of sale unit 16. In step 104, the merchant communicates with the authorization center 14.

In step 106, the authorization center 14 then verifies that the purchaser's credit card account is a valid account and has available credit by querying the issuing financial institution/card issuer 18 with a transaction request message. In step 108, the authorization center also sends a transaction request message to the transaction notification system 30. In step 110, the transaction notification system receives the transaction request message.

The method then moves to step 112, where the computing system 34 retrieves from the database 32 account information associated with the credit card used by the purchaser 10. The account information includes the desired destinations and modes of communications for receipt of a transaction message. In step 114, the computing system 34 generates the transaction message. The transaction message may include information derived from the transaction request message received from the authorization center 14. The transaction message may include the account number, amount of transaction, merchant, location of merchant, and time of transaction.

Next, in step 116, the transaction notification system 30 sends the generated transaction message to the specified destinations, such as the user primary address 36, the user secondary address 38, the associated user address 40 and/or the responsible party address 42. As discussed above, the transaction message may be sent to any specified address. In step 118, the transaction notification system may optionally send the transaction message in a format receivable by a financial software program. In step 120, the financial software program may automatically input the transaction into the associated account.

In step 122, the issuing financial institution/card issuer responds to the query (transaction request message) by either authorizing or rejecting the requested credit card transaction. Next, in step 124, the authorization center then relays the authorization (i.e., approval or rejection) message to the merchant. The authorization center may conduct normal processing of an electronic transaction before, after, or simultaneously with the transmission of messages to the transaction notification system .

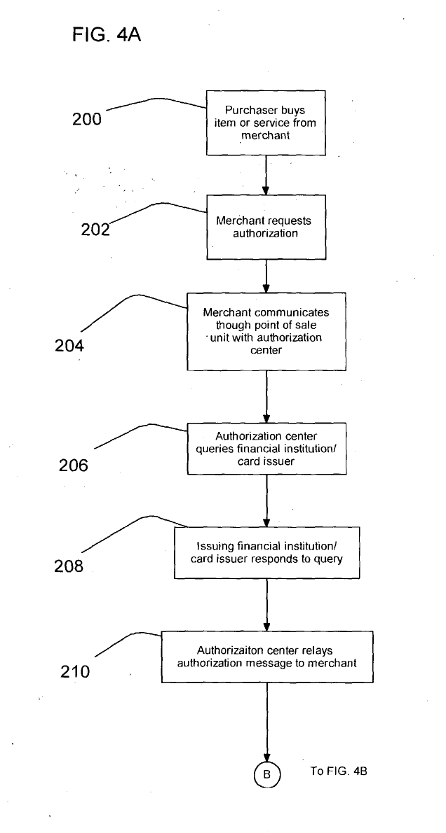

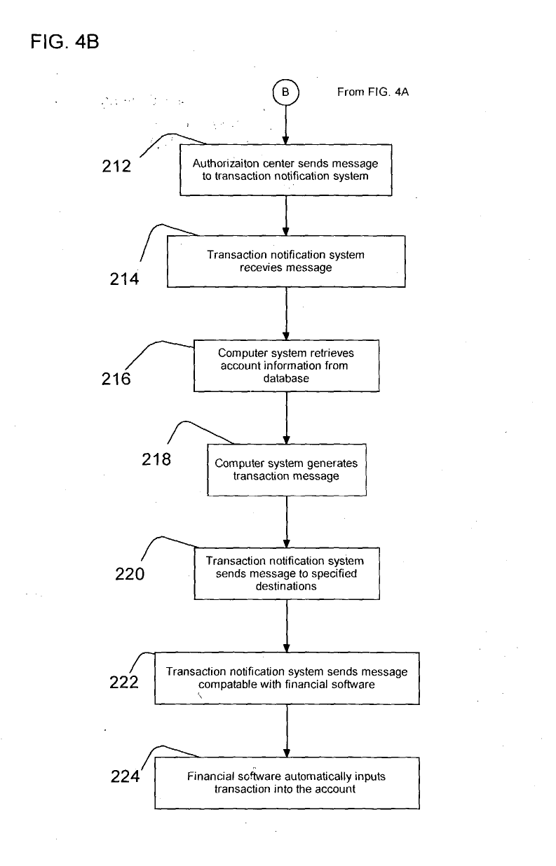

FIGS. 4A and 4B are flow charts outlining the steps for notifying a specified party of an electronic transaction in a second embodiment of the present invention. With reference to FIGS. 2, 4A and 4B, the steps of the method will now be described. Beginning with step 200, the purchaser 10 buys an item or service from the merchant 12 using a credit card. Next, in step 202, the merchant requests authorization for the credit card transaction by communicating with an authorization center 14 through the point of sale unit 16. In step 204, the merchant communicates with the authorization center 14.

In step 206, the authorization center 14 then verifies that the purchaser's credit card account is a valid account and has available credit by querying the issuing financial institution/card issuer 18 with a transaction request message.

In step 208, the issuing financial institution/card issuer responds to the query (transaction request message) by either authorizing or rejecting the requested credit card transaction. Next, in step 210, the authorization center then relays the authorization (i.e., approval or rejection) message to the merchant.

Next, in step 212, the authorization center sends a transaction request/authorization message to the transaction notification system 30. In step 214, the transaction notification system receives the transaction request/authorization message. The method then moves to step 216, where the computing system 34 retrieves from the database 32 account information associated with the credit card used by the purchaser 10. The account information includes the desired destinations and modes of communications for receipt of a transaction message. In step 218, the computing system 34 generates the transaction message. The transaction message may include information derived from the transaction request/authorization message received from the authorization center 14. The transaction message may include the account number, amount of transaction, merchant, location of merchant, and time of transaction. In addition, the transaction message may include information on the authorization of the transaction (i.e., approved or declined).

Next, in step 220, the transaction notification system 30 sends the generated transaction message to the specified destinations, such as the user primary address 36, the user secondary address 38, the associated user address 40 and/or the responsible party address 42. As discussed above, the transaction message may be sent to any specified address. In step 222, the transaction notification system may optionally send the transaction message in a format receivable by a financial software program. In step 224, the financial software program may automatically input the transaction into the associated account.

The present invention may optionally include the capability of temporarily stopping the generation of any transaction message to a specified address. For example, during a gift giving season, such as Christmas, a husband may not wish for the wife to know of a specific transaction associated with a gift. Therefore, in such a situation, a person may desire to temporarily stop any notifications by the transaction notification system for one transaction or all transactions during a specific period of time, a specified destination or specific number of transactions.

The present invention may also be implemented with other interfaces utilized with credit card transaction systems. For example, rather than utilizing a point of sale unit, the credit card user may communicate with a merchant via a user interface, such as telephone or the Internet. The present invention may still be employed to provide transaction notification to one or more destinations.

In an alternate embodiment of the present invention, the authorization center may internally store all information on all credit card accounts. Thus, there may not be a need for the authorization center to query a card issuer or financial institution about a specific credit card account. Additionally, the authorization center may immediately determine the availability of money for a transaction and send that information to the transaction notification system. Although credit card transactions have been illustrated, the present invention may be utilized with any electronic transaction. In an alternate embodiment of the present invention, the authorization center may be incorporated within a financial institution or a card issuer. It should be understood that the present invention may be incorporated within any electronic transaction configuration, either currently being used or implemented within the future. The present invention may provide notification of such electronic transactions as a banking transaction (e.g., electronic transfer, “autodraft,” or deposit).

Alternatively, the authorization center may send two or more separate messages to the transaction notification system indicating various steps of the transaction process. For example, the authorization center may send a first message indicating that a transaction is being conducted. This first message may be triggered when a merchant requests authorization for a credit card transaction from the authorization center. The transaction notification system may then send one or more messages indicating the pending transaction to the specified destinations. Once the authorization center receives an authorization message (approval or disapproval) from the financial institution/card issuer, the authorization center may send a second message to the transaction notification system providing an indication of the authorization message. The transaction notification system may then send a second or subsequent messages to the specified destinations.

The system and method described above offers many advantages over existing credit card transaction systems. The present invention provides timely notification of the completion of each electronic transaction. Additionally, the notification may be sent to more than one destination, which may or may not be associated with the credit card user. In addition, the present invention may be utilized by two or more people sharing a single account, such as a husband and wife. The present invention may also be utilized by an adult financially responsible for a credit card issued to their child. Also, the present invention may be utilized in a corporate or government credit card account, where one or more employees may be using a corporate credit card for business related expenses. The present invention may be implemented, unlike existing systems, in such a manner as to avoid taking precious resources from the authorization center. Rather, the present invention is implemented as a distributed system. In addition, the present invention does not delay transactions waiting for authorizations, especially during peak times (e.g., Christmas).

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. A system for notifying a specified destination of a transaction, said system comprising:
an authorization center receiving authorization requests from a merchant for a specific transaction associated with a specific account, said authorization center authorizing the specific transaction and sending an authorization message to the merchant; and
a transaction notification system for transmitting a transaction message to a specified destination associated with the specific account, said transaction notification system receiving a message from the authorization center upon completion of the transaction, the transaction message being transmitted upon completion of the specific transaction.

2. The system for notifying a specified destination of a transaction of claim 1 wherein the transaction notification system transmits a transaction message to a plurality of specified destinations.

3. The system for notifying a specified destination of a transaction of claim 1 wherein the transaction message includes financial information on the specific transaction.

4. The system for notifying a specified destination of a transaction of claim 3 wherein the financial information includes an amount of the transaction, a time of completion of the transaction, and a location of the transaction.

5. The system for notifying a specified destination of a transaction of claim 1 wherein the authorization center queries a financial institution for authorization of the specific transaction.

6. The system for notifying a specified destination of a transaction of claim 1 wherein the transaction message includes an authorization decision by the authorization center.

7. The system for notifying a specified destination of a transaction of claim 1 wherein the transaction message is compatible with a financial software program tracking the specific account, the transaction message providing transaction information for input into the financial software program.

8. The system for notifying a specified destination of a transaction of claim 1 wherein the transaction is a financial electronic transaction.

9. The system for notifying a specified destination of a transaction of claim 8 wherein the financial electronic transaction is a credit card transaction.

10. The system for notifying a specified destination of a transaction of claim 1 wherein the transaction message is transmitted as an email message to the specific destination.

11. The system for notifying a specified destination of a transaction of claim 1 wherein the transaction message is transmitted as a text message to a communication device.

12. The system for notifying a specified destination of a transaction of claim 1 wherein the transaction message is transmitted as a voice message to a communication device.

13. A method of notifying a specified destination of an electronic transaction by a purchaser, the method comprising the steps of:
conducting an electronic transaction by the purchaser with a merchant using a specified account;
requesting an authorization to an authorization center by the merchant for the electronic transaction;
determining by the authorization center if the electronic transaction is authorized;
sending an authorization message to the merchant for the electronic transaction;
sending a message to a transaction notification system about the completed transaction; and
sending a transaction message by the transaction notification system to the specified destination associated with the specified account, the transaction message providing information about the electronic transaction.

14. The method of notifying a specified destination of an electronic transaction by a purchaser of claim 13 wherein the step of sending a transaction message to the specified destination includes the step of sending a transaction message to a plurality of specified destinations.

15. The method of notifying a specified destination of an electronic transaction by a purchaser of claim 13 wherein the transaction message includes information about an amount of the transaction, a time of completion of the transaction, and a location of the transaction.

16. The method of notifying a specified destination of an electronic transaction by a purchaser of claim 13 wherein the step of determining by the authorization center if the electronic transaction is authorized includes querying a financial institution associated with the specified account for authorization of the specific transaction.

17. The method of notifying a specified destination of an electronic transaction by a purchaser of claim 13 wherein the transaction message includes an authorization decision by the authorization center.

18. The method of notifying a specified destination of an electronic transaction by a purchaser of claim 13 wherein the transaction message is compatible with a financial software program tracking the specific account, the transaction message providing transaction information for input into the financial software program.

19. The method of notifying a specified destination of an electronic transaction by a purchaser of claim 13 wherein the electronic transaction is a credit card transaction.

20. The method of notifying a specified destination of an electronic transaction by a purchaser of claim 13 wherein the step of sending a transaction message to the specified destination includes sending an email message to the specified destination.

21. The method of notifying a specified destination of an electronic transaction by a purchaser of claim 13 wherein the step of sending a transaction message to the specified destination includes sending a text message to a communication device.

22. The method of notifying a specified destination of an electronic transaction by a purchaser of claim 13 wherein the step of sending a transaction message to the specified destination includes sending a voice message to a communication device.

23. The method of notifying a specified destination of an electronic transaction by a purchaser of claim 13 further comprising, after the step of requesting an authorization to an authorization center by the merchant for the electronic transaction, the steps of:
sending a message to a transaction notification system of the pending transaction; and
sending a transaction message by the transaction notification system to the specified destination of the pending transaction.

24. A system for notifying a specified destination of a transaction, said system comprising:
an authorization center receiving authorization requests from a merchant for a specific transaction associated with a specific account, said authorization center authorizing the specific transaction and sending an authorization message to the merchant; and
a transaction notification system for transmitting a transaction message to a specified destination associated with the specific account, said transaction notification system receiving a message from the authorization center during a specific transaction, the transaction message being transmitted during the specific transaction.
